(19) United States
(12) Patent Application Publication
(10) Pub. No.: US 2005/0196124 A1
(43) Pub. Date: Sep. 8, 2005

(54) Automated topology detection in a data processing system

(75) Inventors: Alfredo Aldereguia, Cary, NC (US); Ralph Murray Begun, Raleigh, NC (US); Grace Ann Richter, Raleigh, NC (US)

Correspondence Address: LALLY & LALLY, L.L.P., P. O. BOX 684749, AUSTIN, TX, 78768-4749, US

(73) Assignee: International Business Machines Corporation, Armonk, NY (US)

(21) Appl. No.: 10/777,508

(22) Filed: Feb. 12, 2004

(51) Int. Cl. G02B 6/00

(52) U.S. Cl. 385/147

(57) ABSTRACT

A data processing system suitable for use in a scalable system, including a first set of processors, a first system memory, and scalability logic to connect the data processing system to a second data processing system to form a scaled system. A set of scalability ports are connected to the scalability logic to receive scalability cables connecting the first system to the second system or to another processor board within the same chassis. The system includes system management to cause each of the system's scalability ports to issue an identifiable signal. System management also detects the reception of an identifiable signal, sent by another system, received by any of the scalability ports and reports the reception of the signal to a system management of the second system to determine which ports of the two systems are connected by the cable.

### BACKGROUND

1. Field of the Present Invention

The invention is in the field of data processing systems and more particularly in the field of interconnected or scalable data processing systems.

2. History of Related Art

In the field of data processing systems, scalability is an attractive feature for many customers because they do not have to scrap their existing systems when their computing and/or storage requirements increase or otherwise change. Scalability refers, in some cases, to adding hardware within an existing board and/or chassis. In other implementations, scalability is achieved by connecting two or more systems together via dedicated ports and high speed cables. Scalable computer systems of this type, as a general rule, have multiple scalability cables connecting the various systems together. It is worth noting here that the scalability cables referred to in this disclosure are distinct from the network cables (such as Ethernet cables) that connect system in a local area network.

It is generally cumbersome to connect and/or trace scalability cables quickly and accurately, especially where space is at a premium such as in densely populated data centers and the like. In at least some applications, the scalability cables connecting multiple systems must be connected in a specified manner if the full performance benefit of scaling is to be achieved. It would be desirable to implement a method and system for automatically mapping the scalability cabling (i.e., determining which ports of which systems are connected) in a data processing system. It would be further desirable if the implemented system worked independently of the actual cabling such that the automated cabling mapping system remains functional even if the cables are thoroughly “misconnected.”

### SUMMARY OF THE INVENTION

A method and data processing system suitable for use in a scalable system. The system includes a first set of processors, a first system memory, and scalability logic to connect the data processing system to a second data processing system to form a scaled system. A set of scalability ports are connected to the scalability logic to receive scalability cables connecting the first system to the second system (or to another processor board within the same system). The system includes system management to cause each of the system's scalability ports to issue an identifiable signal. System management also detects the reception of an identifiable signal, sent by another system (or by the same system), received by any of the scalability ports and reports the reception of the signal to a system management of the second system (or the same system) to determine which ports of the two systems are connected by the cable. The system management might include a service processor connected to the system via an adapter card and wherein the service processor is connected to a service processor of other systems via a network medium. The system management causes a scalability port to issue an identifiable signal by causing the assertion of a bit in a register corresponding to the set of scalability ports. The scalability port register is implemented in a programmable logic device. The system management might include means for determining a timeout condition following assertion of a bit, and identifying the corresponding scalability port open. The system management further includes code means for using the scalability information to generate a graphical image of scalability interconnections.

### BRIEF DESCRIPTION OF THE DRAWINGS

Other objects and advantages of the invention will become apparent upon reading the following detailed description and upon reference to the accompanying drawings in which:

FIG. 1 is a block diagram of selected elements of a data processing system suitable for use with an embodiment of the present invention;

FIG. 2 is a diagram of a scalable data processing system according to an embodiment of the present invention;

FIG. 3 illustrates details of the data processing system of FIG. 2 emphasizing details of the invention; and

FIG. 4 is a flow diagram of a method of verifying the topology of the data processing system of FIG. 2 and FIG. 3 according to one embodiment of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

Generally speaking, the present invention is concerned with automatic detection and mapping of the interconnections (referred to as the scalability connections or scalability cables) between two or more systems (or between different processor boards within the same system) that constitute a “scaled” system. Programmable logic on a processor board is configured to provide a system management unit read/write access to a low level register (the scalability port register or SPR). Bits in the SPR correspond to specific scalability ports of the system. When two or more individual systems (or different processor boards within a single system) are interconnected via one or more scalability cables, the system management unit can determine a mapping or topology of the scalability cables by asserting specified bits in the SPR. When one of the SPR bits is asserted, an identifiable signal such as a pulse train is driven on the scalability port corresponding to the asserted SPR bit. If a scalability cable connects this scalability port to another scalability port, the pulse train will be transmitted over the cable and received at the other port. When the pulse is received, programmable logic on the receiving system recognizes the unique pulse train as a topology detection pulse train and sets a bit in its SPR and initiates an interrupt that is detected by the system management unit of the system that received the pulse train. The system management unit handles the interrupt by inspecting the SPR bits to determine which scalability port received the pulse train. This information can then be transmitted among the system management devices, using standard TCP/IP over Ethernet, for example, to derive a scalability topology or mapping.

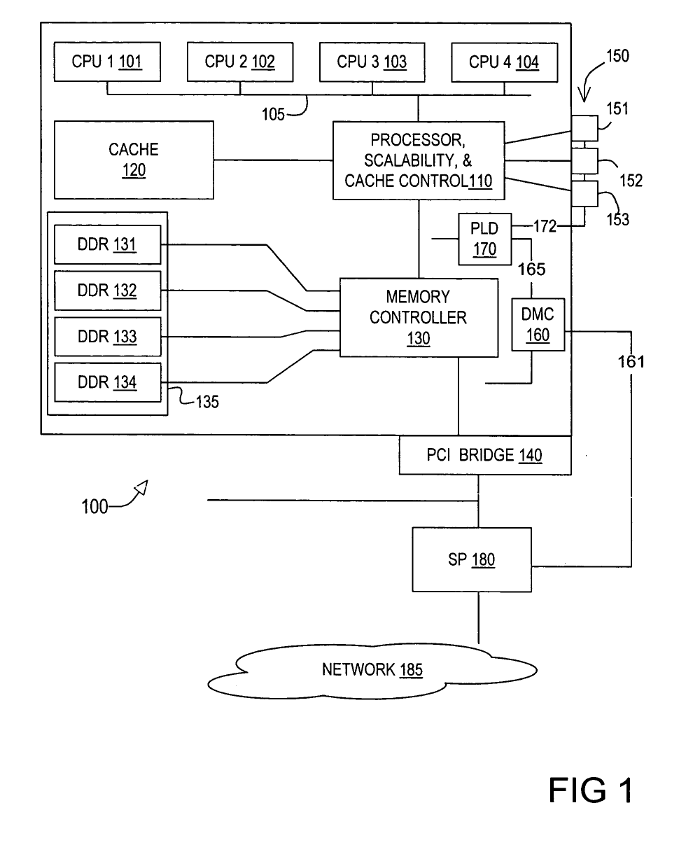

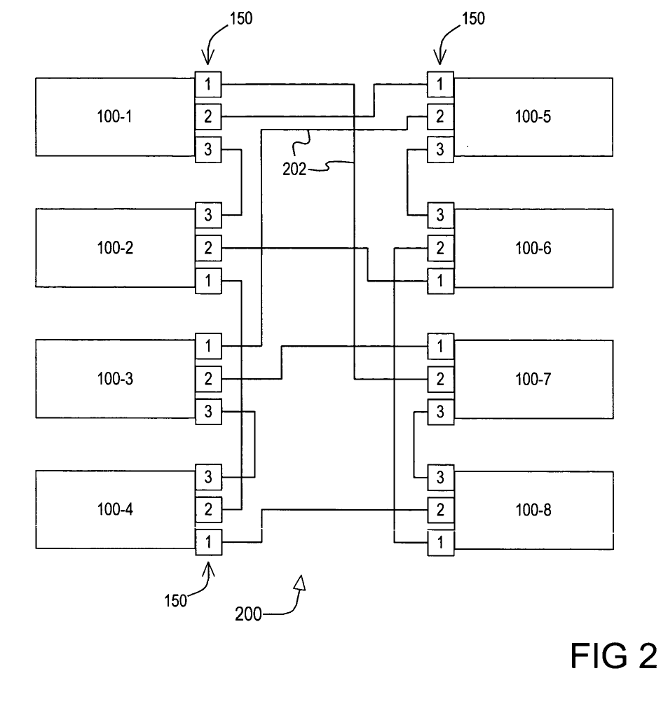

Referring now to the drawings, FIG. 1 is a block diagram of selected elements of a data processing system 100 according to one embodiment of the present invention. System 100 represents an individual data processing system that can be interconnected to one or more other such systems to form a scaled data system described below with respect to FIG. 2. For purposes of this invention, a scaled system includes any system in which two or more symmetric multiprocessor SMP systems, such as system 100, are interconnected to form a larger multiprocessor system capable of functioning under a single operating system image.

In the depicted embodiment, system 100 is a multiprocessor system that includes a set of central processing units (CPU's) 101 through 104. Each of the processors 101 through 104 is connected to a shared bus 105. An external cache memory 120 is connected to shared bus 105 through an intervening Processor Scalability and Cache control unit 110, which also controls access to a set of three scalability ports 151 through 153. A memory controller 130 provides a bridge between system memory 135 comprised of a bank of double data rate (DDR) dynamic RAM modules 131 through 134. Although the depicted system memory 135 is implemented with DDR modules, the type of system memory used is an implementation detail not germane to the present invention. A PCI bridge 140 serves as a bridge to external I/O devices (not shown) of system 100. These external devices likely include a control unit, such as a SCSI controller, for some form of persistent storage.

In an embodiment exemplified by the IBM xSeries® 445, the CPU's 101 through 104 are IA-32 Xeon® processors from Intel Corporation. System 100 is designed as a scalable system that may be interconnected with other like systems to form a more powerful data processing system sharing the processing, memory, and I/O resources of both systems thereby enabling a customer to increase its computer power when needed without discarding its existing systems. In one embodiment, the elements of system 100 as depicted in FIG. 1 are implemented on a single planar (printed circuit board) that is sometimes referred to as processor board or a Central Electronics Complex (CEC). In such an implementation, a first level of scalability is achieved by enabling two such CEC's to be housed and interconnected within a single chassis. With each CEC capable of accommodating as many as 4 processors, a single chassis system might include as many as 8 processors. Such a system is sometimes referred to as an 8-way system. In a two chassis system, with each chassis including 8 processors, the present invention is scalable to a 16-way system, or to a 32-way system with 4 chassis. For the remainder of this disclosure an individual system refers to an individual CEC or processor board and a scaled system refers to a system in which two or more individual systems are interconnected. Thus, in some implementations, the first and second individual systems may reside within a single chassis.

Scaling of a system such as system 100 is achieved by interconnecting two or more system CEC's with high speed scalability cables. In the depicted embodiment, the scalability cables connect to one of the three scalability ports 151-153 (collectively referred to as scalability ports 150) that are connected to the PSC control unit 110. In the case of the x445, the scalability interconnects are implemented with Infiniband-like connectors (although the interconnect is not an Infiniband compliant link). The scalability interconnections must be done appropriately to prevent unintentionally disabling hardware. An improper scalability interconnection, for example, might result in some of the processors being effectively disabled.

Other elements of system 100 as depicted in FIG. 1 include a Service Processor (SP) 180 and a Drawer Management Controller (DMC) 160. These two elements together form a System Management Unit of system 100. In one embodiment, SP 180 is implemented as a PCI adapter card, such as the Remote Supervisor Adapter (RSA) product from IBM Corporation. In this embodiment, SP 180 includes independent power, in-band and out-band support through IBM Director®, graphics/text console redirection for remote control, predictive failure analysis on memory, power, and hard drives, temperature ad voltage monitoring with settable thresholds, remote firmware update, and alert forwarding.

The hard drives, temperature sensors, and voltage monitors are accessible to SP 180 through DMC 160, which is likely implemented on the system's CEC. SP 180 and DMC 160 communicate in the depicted embodiment through a dedicated RS485 serial link 161. DMC 160 communicates to various devices using an I2C bus 165. I2C is a 2-wire serial bus developed by Philips that is widely supported on a variety of devices. Among the devices accessible to DMC 160 via I2C bus 165 is a programmable logic device (PLD) 170. PLD 170 implements various special purpose functions on the CEC. In the present invention, one of the functions of PLD 170 is to enable a user or program to select a scalability port 151, 152, or 153 and to transmit a unique pulse train to the selected port via a scalability port bus 172 as further described below.

In a densely populated data center, there may be a significant number of systems in use and the space allocated to each system may be limited. For these reasons and others, it can be difficult to determine the source and destination of a large number of similar looking scalability cables that all plug into similar looking ports on similar looking devices. The present invention addresses this issue by providing for an automated system for obtaining a mapping of the scalability cables as they have been connected by the user or system administrator.

Referring now to FIG. 2, a diagram of a scaled system 200 according to one embodiment of the present invention is depicted. In the depicted embodiment, a 32-way system 200 is achieved by interconnecting multiple systems such as the system 100 depicted in FIG. 1 and described above. More specifically, the depicted embodiment of scaled system 200 includes a set of 8, interconnected systems 100-1 through 100-8, each of which may be implemented with a system 100 as depicted in FIG. 1. Each system 100-1 through 100-8 includes a set of three scalability ports 150. Each of a set of scalability cables 202 interconnects between a pair of scalability ports 150.

One embodiment of the present invention generates a mapping of the set of scalability cables 202 so that a system administrator can view the scalability interconnections without having to trace each interconnect manually. When the set of scalability cables 202 are properly connected, scaled system 200 has as many as 32 processors executing under a single operating system image. In addition to the scaled processing power, each system 100 is also capable of contributing a large amount of system memory, cache memory, and I/O capability to the scaled system 200. If, however, the scalability cables 202 are improperly connected, scaled system 200 will not have the processing power that it has when properly connected because one or more of the processors will be effectively “cut out” of the overall system.

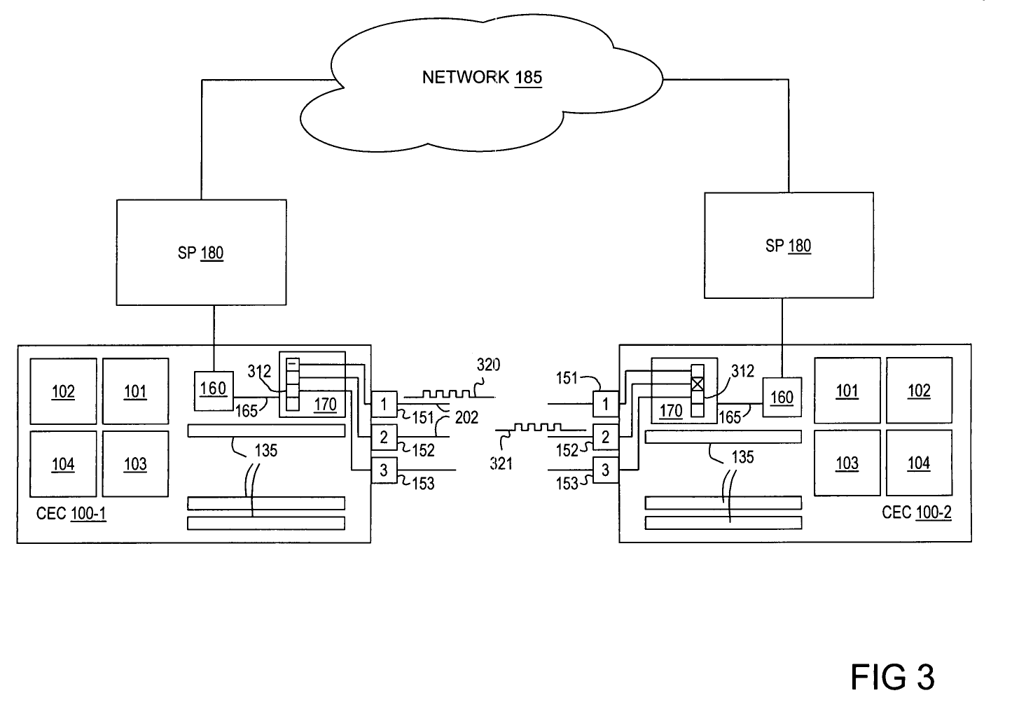

Referring now to FIG. 3, additional detail of two of the systems 100 depicted in FIG. 2 are shown to emphasize the capability of the present invention to determine the manner in which the scalability cables are connected. Each system 100 has system management functionality enabled by SP 180 and DMC 160. Each system's SP 180 connects to a network 185, which is likely an Ethernet network, and communicates with network 185 using standard TCP/IP. SP 180 also connects to the DMC 160 over an internal RS485 link. DMC 160 connects to individual components of system 100 over an I2C bus. In the depicted embodiment, the I2C bus connects DMC 160 to PLD 170 on each of the CEC's 100-1 and 100-2.

In one embodiment, PLD's 170 include a SPR 312 that is accessible for reading or writing via I2C bus 165. In one embodiment, PLD's 170 are configured to respond when a SPR 312 bit is set by sending a unique pulse train to the scalability port 151, 152, or 153 that corresponds to the bit that was set. In one embodiment, SP 180 initiates the scalability cable mapping process by requesting DMC 160 to set the bit in SPR 312 corresponding to the scalability port “under test.” In response to bit in SPR 312 being set, PLD 170 on the first CEC 100-1 drives a predetermined, unique pulse train on the scalability port 151, 152, or 153 corresponding to the SPR bit that was set. If a scalability cable 202 is connected at one end to the scalability port driving the pulse train and connected at the other end to another scalability port (possibly on another system), the pulse train will be transmitted over the scalability cable 202 and received at the other end. In FIG. 3, one can see a 1 written into the bit that is associated with the first scalability port 151 of system 100-1 causing PLD 170 to send the pulse train (reference numeral 320) over the scalability cable (if any) attached to scalability port 151. In the depicted embodiment, a four-pulse signal 320 is used as the predetermined signal. Four pulses reduces the chances of a spurious noise or other effect appearing as a valid signal without consuming an excessive amount of time and/or processing to recognize.

The signal 320 travels down its corresponding scalability cable 202 and, assuming cable is attached to the scalability port of another system (or to a port on the same system), will eventually be received by the scalability port of said system. In the event that there is no cable attached a time-out will occur, indicating that no cable is currently connected to the respective scalability port or that the connection exists outside of the system domain. In FIG. 3, the signal 320 that is sent from scalability port 1 is shown as arriving at scalability port 2 of second system 100-2. The PLD 170 of CEC 101-2 is configured to record the receipt of the pulse train by setting the appropriate bit in SPR 312.

In one embodiment, the receipt of an appropriate signal (the four-pulse pulse train in this case) causes the system 100-2 that receives the signal to issue an interrupt on I2C bus 165. The interrupt is detected by DMC 160, which then reads the register 312 in programmable logic 170 to determine which port received the pulse. DMC 160 can then report the identification of the determined port to SP 180. The various SP's 180 of the various systems can communicate with each other via the Ethernet network to resolve the mapping of the first scalability port of first system 100-1 to the second scalability port of second system 100-2.

In one embodiment, the scalability port bits in each register 312 are cleared after every mapped pair is determined to avoid erroneous results. The use of system management (180, 160) to determine the scalability mapping is beneficial in the context of the present invention because system management 180 is “side-band” with respect to the systems 100. If the scalability cables 202 interconnecting systems 100 to form scaled system 200 of FIG. 2 are improperly connected, some or all scaled system's functionality may be lost and it might not be possible to conduct a review of the scaled systems interconnects.

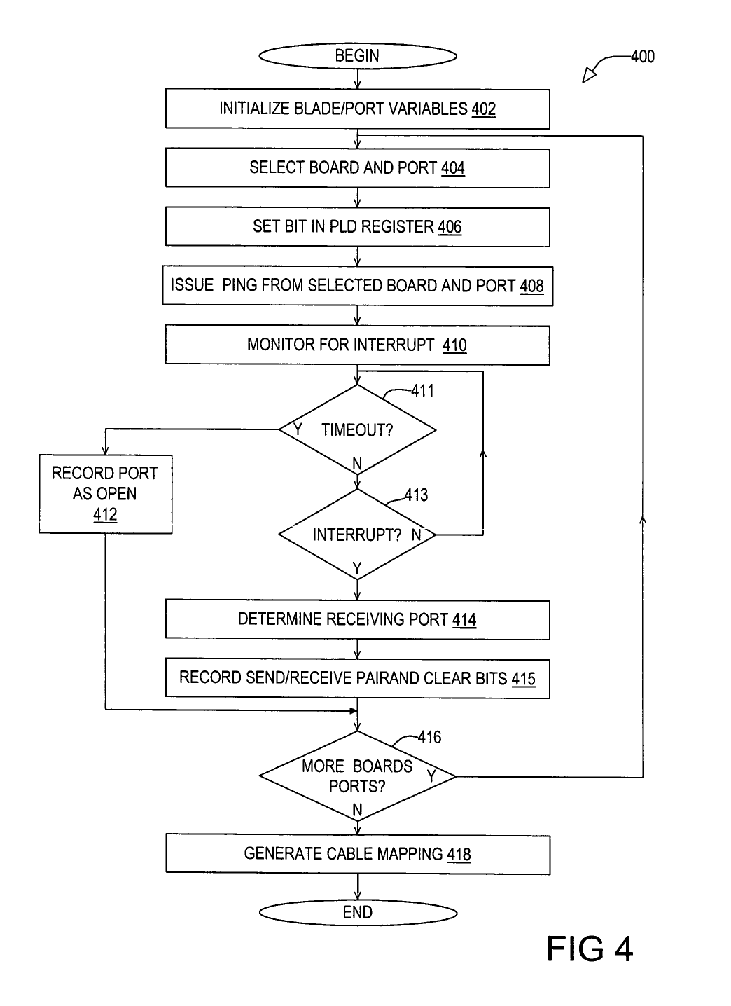

Portions of the invention may be implemented as software or firmware that includes a set of computer executable instructions for mapping scalability interconnections in a scaled data processing system. Referring to FIG. 4, a flow diagram of a method 400 of mapping the interconnections between a pair of data processing systems according to one embodiment of the present invention is depicted. In the depicted embodiment, method 400 includes an initialization step (block 402) in which the CEC's and their corresponding ports are cleared and initialized (e.g., current CEC is 100-1; current port is port 1 151). The system management is capable of learning or detecting at least some of the system's functional units including how many scalability ports 151-153 each system has. In the example under consideration, the number of scalability ports is hardwired such that system management knows that each system 100 has three scalability ports 151-153. In other implementations, the assignment of scalability ports could vary dynamically based upon current loading and/or preferences. In still other embodiments, the invention is more generally concerned with using systems management functionality to map proprietary port interconnections between two or more devices in a system or network.

After initializing the board/port variables, the current board and current port are selected in block 404. In a typical embodiment, the system management will simply begin with the first board and first port. When a board and port have been selected, system management of the currently selected board sets (block 406) an SPR bit corresponding to the selected port. The assertion of the appropriate bit in the SPR causes the programmable logic to transmit a predetermined pulse train or signal (block 408) via the selected board and port.

After the pulse is transmitted, system management of the transmitting system monitors (block 410) for an interrupt indicating that the pulse train was received. If no interrupt is detected and a predetermined period of time expires, a timeout condition occurs (block 411) and the system management interprets and record (block 412) the timeout as indicating that the port from which the pulse train was issued is not connected to any other compatible system. If an interrupt is detected (block 413) before the timeout condition occurs, the system management on the system that issued the interrupt reads the system's SPR to determine (block 414) which system received the pulse train. The system management on the sending side of the pulse train and the system management on the receiving side of the pulse train can transmit or exchange information to record a pair of ports as being connected (referred to as a send/receive pair). The process continues until (block 416) all boards and scalability ports have been mapped.

In the depicted embodiment, method 400 includes generating (block 418) a mapping of the port pairs in some graphical form of image that can quickly convey the current connections. In other embodiments, system 400 might include the ability to verify whether the determined mapping is correct and to issue an alert or interrupt if it is incorrect.

Method 400 may be executed following each system reset or power on event in one embodiment. In another embodiment, it may be a system setup procedure that may only be invoked by an administrator or field service person. By automating the determination of the current mapping, the invention beneficially simplifies life for administrators and technicians. Using the system management to perform this task is ideal because any misconfiguration of the cables might produce problems with the system's functionality.

It will be apparent to those skilled in the art having the benefit of this disclosure that the present invention contemplates a system and method of automated cable detection to insure appropriate connections in a data processing system. It is understood that the form of the invention shown and described in the detailed description and the drawings are to be taken merely as presently preferred examples. It is intended that the following claims be interpreted broadly to embrace all the variations of the preferred embodiments disclosed.

1. A scalable data processing system, including:
a first set of central processing units;
a first system memory accessible to the first set of processors;
scalability logic to connect the data processing system to a second data processing system, having a second set of processors and a second system memory, to form a scaled system;
a set of scalability ports connected to the scalability logic to receive scalability cables connecting the first system to the second system; and
system management to cause each of the system's scalability ports to issue an identifiable signal and further configured to detect the reception of an identifiable signal, sent by another system, by any of the scalability ports and to report the reception of the signal to a system management of the second system to determine which ports of the two systems are connected by the cable.

2. The system of claim 1, wherein the system management includes a service processor connected to the system via an adapter card and wherein the service processor is connected to a service processor of other systems via a network medium.

3. The system of claim 1, wherein the system management causes a scalability port to issue an identifiable signal by causing the assertion of a bit in a register corresponding to the set of scalability ports.

4. The system of claim 3, wherein the scalability port register is implemented in a programmable logic device.

5. The system of claim 1, wherein the system management further includes controller logic connected to the service processor via a dedicated serial connection and connected to the programmable logic device via an I2C bus.

6. The system of claim 1, wherein the system management includes means for determining a timeout condition following assertion of a bit, and identifying the corresponding scalability port open.

7. The system of claim 1, wherein the system management further includes code means for using the scalability information to generate a graphical image of scalability interconections.

8. A method of determining scalability cabling between at least two scalable data processing systems, comprising:
driving an identifiable signal on a first scalability port of a first system;
responsive to receiving the identifiable signal by a second system, determining which scalability port of the second system received the distinctive signal;
informing the first system of the reception of the distinctive signal by the determined scalability port of the second system and recording the first scalability port of the first system and the scalability port of the second system as being connected by a scalability cable.

9. The method of claim 8, further comprising detecting a timeout by the first system and, responsive thereto, identifying the first scalability port as being unconnected.

10. The method of claim 8, further comprising, iterating the sequence of claim 8, until all scalability ports have been accounted for.

11. The method of claim 10, further comprising generating a graphical image of the scalability cable connections.

12. The method of claim 8, wherein driving the signal on the first scalability port comprises setting a bit in a register associated with the set of scalability ports.

13. The method of claim 8, wherein setting a bit in the register comprises a controller writing to a specified address on an I2C bus connecting the controller to the register.

14. The method of claim 8, wherein determining the scalability port that received the signal includes reading the bits in a register associated with scalability port.

15. A computer program product comprising computer executable instructions, stored on a computer readable medium, for determining scalability cabling between at least two scalable data processing systems, comprising:
computer code means for driving an identifiable signal on a first scalability port of a first system;
responsive to receiving the identifiable signal by a second system, computer code means for determining which scalability port of the second system received the distinctive signal;
computer code means for informing the first system of the reception of the distinctive signal by the determined scalability port of the second system and recording the first scalability port of the first system and the scalability port of the second system as being connected by a scalability cable.

16. The computer program product of claim 15, further comprising code means for detecting a timeout by the first system and, responsive thereto, identifying the first scalability port as being unconnected.

17. The computer program product of claim 15, further comprising, code means for iterating the sequence of claim 15, until all scalability ports have been accounted for.

18. The computer program product of claim 19, further comprising code means for generating a graphical image of the scalability cable connections.

19. The computer program product of claim 15, wherein the code means for driving the signal on the first scalability port comprises code means for setting a bit in a register associated with the set of scalability ports.

20. The computer program product of claim 15, wherein code means for setting a bit in the register comprises a controller writing to a specified address on an I2C bus connecting the controller to the register.

21. The computer program product of claim 15, wherein the code means for determining the scalability port that received the signal includes code means for reading the bits in a register associated with scalability port.
